(19) United States
(12) Patent Application Publication
(10) Pub. No.: US 2016/0198673 A1
(43) Pub. Date: Jul. 14, 2016

(54) Disposable Animal Litter Container

(71) Applicant: Renee D. Waid, Ashtabula, OH (US)

(72) Inventor: Renee D. Waid, Ashtabula, OH (US)

(21) Appl. No.: 14/990,945

(22) Filed: Jan. 8, 2016

Related U.S. Application Data
(60) Provisional application No. 62/100,944, filed on Jan. 8, 2015.

(51) Int. Cl. A01K 1/01

(52) U.S. Cl. CPC A01K 1/0125; A01K 1/0114

(57) ABSTRACT

There is provided a disposable animal litter container comprising a single foldable blank of material. The foldable blank of material comprises a base portion, a pair of end portions, a pair of side portions, a lid portion on each side portion, and may also include a handle portion on each lid portion. The litter container is easily constructed by a completing a series of folds and by the use of integral adhesive strips. After use, the litter container is easily sealed and transported for disposal.

### CROSS REFERENCE TO RELATED APPLICATION

This application claims priority to and the benefit of U.S. Provisional Patent Application No. 62/100,944, filed on Jan. 8, 2015 which is incorporated herein by reference in its entirety.

### TECHNICAL FIELD

This invention relates generally to litter containers designed for pets and, more particularly, to disposable litter containers that are formed as a flat blank and are easy to construct, use, and dispose of.

### BACKGROUND OF THE INVENTION

Conventional litter boxes are generally relatively large plastic boxes in which litter is placed for use. After multiple uses by a pet, such litter boxes can be unsanitary, odorous, and frustrating to empty and clean. Conventional litter boxes are generally cleaned by dumping the used litter into plastic garbage bags. These bags can be very difficult to handle due to their weight or may break, creating a mess that requires a substantial amount of clean-up. Furthermore, once the litter is emptied from the litter container, the litter container must then be cleaned out and disinfected, requiring time and labor and the ability and resources to clean and disinfect the box. For many situations, such litter boxes are not easily handled, such as for people living in apartments or condominiums for example. In such environments, disposal of the used litter may be difficult and/or the pet owner may not have access to a large sink or the like for cleaning and disinfecting the box for reuse.

Although there have been attempts at providing a disposable litter container, such devices are difficult to construct and use. Further, they do not provide any simple and convenient way for a user to cover, and transport the used litter container for disposal. Therefore, there is a need for a litter container that is formed as a flat blank for shipping and storage, and is easily constructed and used, as well as easily and quickly disposed of in a sanitary manner.

### SUMMARY OF INVENTION

The invention overcomes the shortcomings and limitations of the prior art units discussed above and teaches a disposable litter container that is easily shipped and stored, easily constructed and used, and easily closed up for simple disposal.

In some embodiments, a disposable animal litter container comprises a unitary blank of material, the blank of material comprising a base portion, a pair of end portions and a pair of side portions. The end portions are foldably connected to the base portion on opposing ends of the base portion, and the side portions are foldably connected to the base portion on opposing sides of the base portion. The end portions and side portions are positioned in diametrically opposed relationship and one of the pair of side portions or pair of end portions have an adhesive over at least a portion thereof. Upon folding up the pair of end portions, and folding up the pair of side portions, the adhesive allows each side portion to be adhered to both end portions, thereby forming an enclosed interior volume with an open top for placement of litter.

### DESCRIPTION OF THE FIGURES

The structure, operation and advantages of a presently preferred embodiment of this invention will become further apparent upon consideration of the following Description, taken in conjunction with the accompanying FIGS. and examples, wherein:

FIG. 1 is a top view of the disposable litter container in its flat, unconstructed form;

FIG. 2 is a top view of the disposable litter container in its initial stage of construction;

FIG. 3 is a perspective view of a partially constructed disposable litter container;

FIG. 4 is a perspective view of a constructed disposable litter container being filled with litter;

FIG. 5 is a side view of a constructed disposable litter container in use by a cat;

FIG. 6 depicts a disposable litter container being closed after use, prior to disposal; and

FIG. 7 is a perspective view of a disposable litter container closed, latched, and sealed prior to disposal.

FIG. 8 is a top view of another example of the disposable litter container in its flat, unconstructed form;

FIG. 9 is a perspective view of a constructed disposable litter container of the example of FIG. 8; and

FIG. 10 is a top view of another example of the disposable litter container in its flat, unconstructed form.

### DETAILED DESCRIPTION OF THE INVENTION

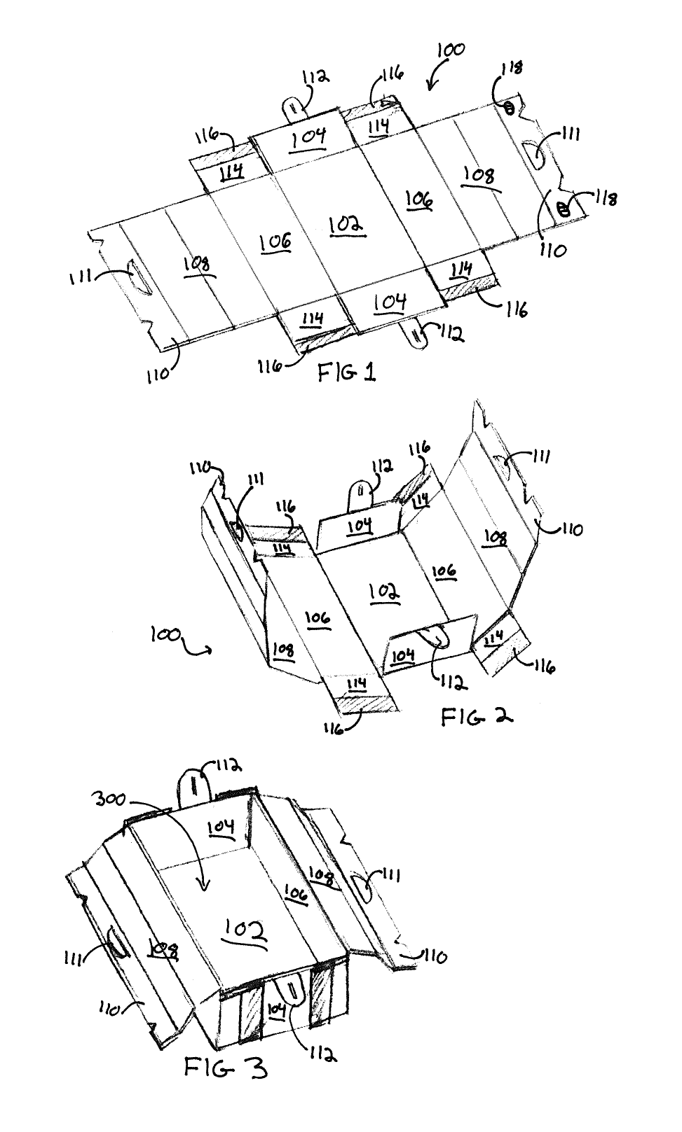

Referring now to FIG. 1, an example of a disposable litter container according to the invention is shown. The container in this example is formed as a unitary flat blank of material 100 having an interior or top surface and exterior or bottom surface. The blank 100 can be shipped and stored as a flat sheet or as a pack of multiple flat blanks 100. In this manner, the disposable litter container is easily stored until use is desired, making it ideal for environments where storage space is limited, such as apartments or condominiums. In this example, the flat blank of material 100 comprises of a base portion 102, a pair of opposing end portion 104, a pair of opposing side portions 106, a pair of lid portions 108 associated with each side portion, and a pair of handle portions 110. The end portions 104 are foldably connected to the base portion on opposing ends of the base portion 102. The side portions 106 are foldably connected to the base portion 102 on opposing sides of the base portion 102. Each side portion 106 comprises a pair of opposing connecting tabs 114 adjacent the end portions 104. Each connecting tab 114 has an adhesive strip 116 provided on the connecting tab 114. The adhesive strip 116 has a removable release liner to protect the adhesive until use is desired. Alternatively, the end portions 104 could be provided with a tab portion with an adhesive to allow the end portions 104 to be secured to the side portions 106 when the container is assembled as will be described below. Other suitable mechanisms for securing the end portions 104 and side portions 106 to one another may be used. A lid portion 108 is foldably connected to each side portion 106. A handle portion 110 is foldably connected to each lid portion 108. Each handle portion 110 may include a cutout that functions as a handle 111 when the container is in its closed operative configuration as will be seen. The foldable connections between portions in the flat blank of material 100 may be formed by scoring of the material to make a weakened zone which is easily folded.

In an embodiment, the flat blank of material 100 is made of cardboard. At least a portion of the flat blank of material 100 has a layer of moisture proof coating in order to prevent urine from damaging the material. In an example, a wax or other moisture proof coating may be provided on the interior side of the bottom portion 102, and to ensure no leakage, on the interior side of the end portions 104 and side portions 106. In this example, the flat blank of material 100 is made of biodegradable material. In further embodiments, the flat sheet of material 100 may be scented and/or formed to have the exterior surface colored or imprinted with a design or other decoration to enhance use in a living space.

Referring now to FIGS. 2-3, the disposable animal litter container is constructed by first folding up the pair of end portions 104 so that the angle between the base portion 102 and the end portions 104 is approximately 90°. The next step involves folding up both side portions 106 to perpendicularly meet the end portions 104. The side portions 106 are connected to the end portions 104 by way of the adhesive strips 116 on the connecting tabs 114. This adhesion is accomplished by first removing the release liner from the adhesive strips 116 on the connecting tabs 114. The connecting tabs 114 are then bent inward and pressed against the corresponding end portion 104 so that the adhesive strips 116 hold the side portions 106 securely in place perpendicular to the end portions 104 as shown in FIG. 3. This constructed litter container forms an enclosed interior volume 300 with an open top.

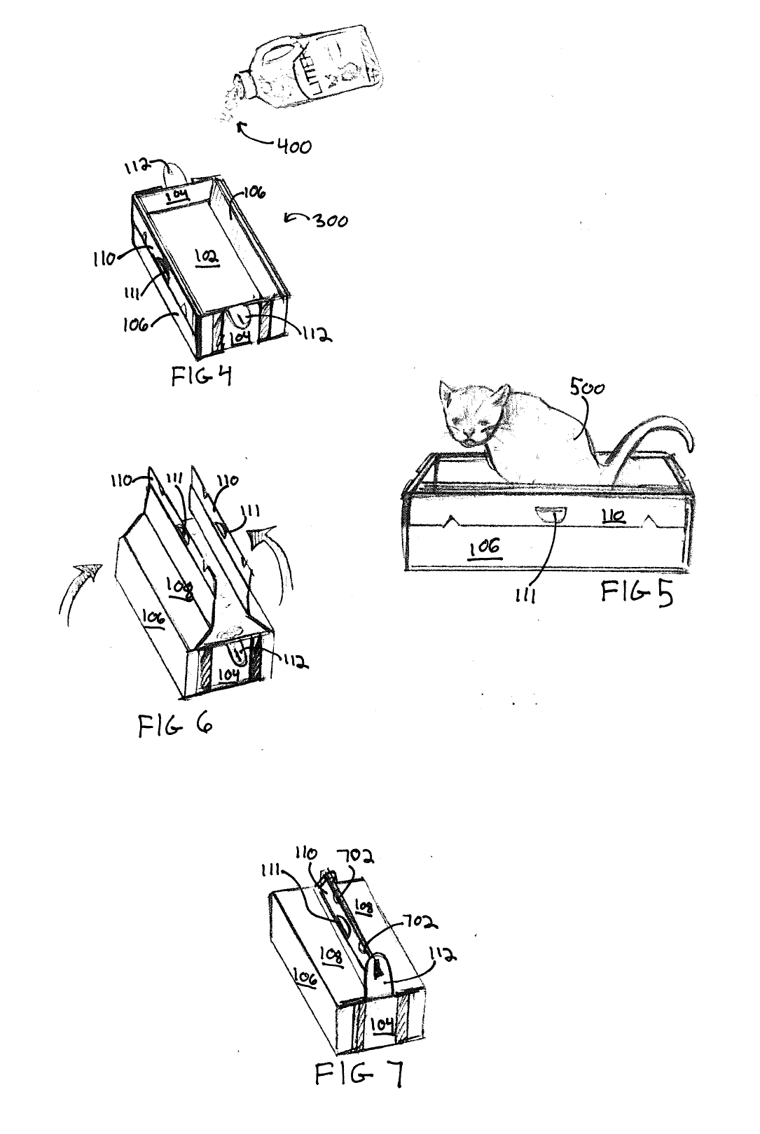

As shown in FIG. 4, the lid portions 108 include a plurality of panels that are foldable into a position adjacent the side portion 106, along with lid portion 108, until the lid portion 108 and handle portion 110 is moved to the closed position described below. The plurality of panels in lid portion 108 may be secured in the position adjacent the side portion 106 by an adhesive tab or tabs provided on the exterior surfaces of each panel section in portion 108. In this manner, the lid portions 108 and handle portions 110 can be folded down to be positioned adjacent the exterior of the side portions 106 and secured to the side portions 106 so that they do not take up extra space or interfere with an animal attempting to use the disposable litter container. Other suitable methods for securing the lid portions 108 and handle portions 110 to the exterior of the side portions 106 may be used. For example, as an alternative to the use of an, hook and loop fasteners, tape, or the like may be used. The accordion-style fold of the plurality of panels in the lid portions 108 also offers additional side support for the container. Once the litter container is constructed and in its operative condition, it is capable of receiving and holding animal litter 400.

Referring now to FIG. 5, an animal 500 may use the disposable litter container similarly to a conventional litter container. The disposable litter container may be a variety of sizes to accommodate different animals or animals of different sizes. In an exemplary embodiment, the litter container is eighteen inches in length, thirteen inches in width, and eight inches in height when in its operative configuration.

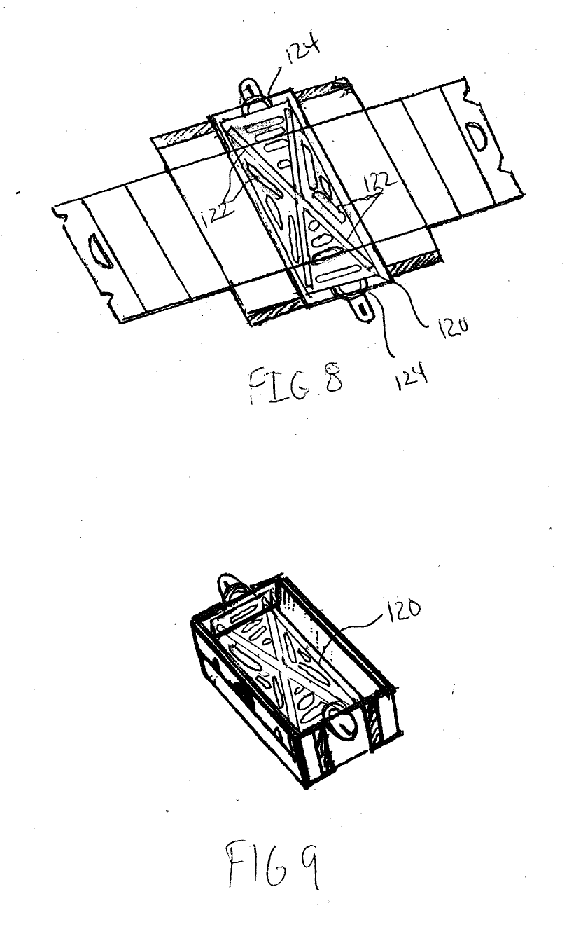

Referring now to FIGS. 6-7, when it is time for the disposable litter container to be disposed of, the lid portions 108 and handle portions 110 are lifted up and brought in towards each other in such a fashion that the lid portions 108 end up positioned horizontally and enclose the top of the enclosed interior volume 300 formed by the constructed litter container. The handle portions 110 are brought together in a generally vertical orientation so that the openings 111 are aligned with and adjacent each other. At this point, the interior volume 300 of the disposable litter container is completely enclosed, and effectively sealed to enclose the used litter and odors associated therewith. Associated with each end portion 104 may be a latch tab 112 which is used to secure the lid portions 108 when the disposable litter container is closed. The latch tab 112 comprises an opening such as a slot or a hole. The latch tabs 112 may be folded up so that the corners of the handle portion 110 can be inserted into the slot, hole, or other opening located in the latch tabs 112. In an embodiment, each handle portion 110 comprises a notch on each end that engages and is secured by the corresponding latch tab 112. Alternatively or in addition, there may be provided one or more adhesive tabs 118 (see FIG. 1) on one or both of the handle portions 110, to allow the handle portions 110 to be secured to one another when in this closed position. In another embodiment, at least one sticker 702 (see FIG. 7) is provided to allow the handle portions 110 to be secured to one another. The sticker 702 is placed over both handle portions 110 at the point where the two handle portions 110 meet. The purpose of the adhesive tab(s) 118 or sticker 702 is to seal the disposable litter container in preparation for transportation for disposal. FIG. 7 displays a, sealed disposable litter container. At this point, the sealed disposable litter container may be easily lifted by the handle portions 110 via the openings 111 which are aligned with one another to allow transportation and disposal with no mess. The contents of the litter container, which may include animal litter and animal waste, are sealed within the interior volume.

In certain embodiments, the disposable litter container is packaged as a kit. The kit may comprise one or more flat blanks of material 100, an amount of animal litter 400, and if desired, sealing stickers 702, and instructions. The flat blank of material 100, animal litter 400, and sticker may be biodegradable.

In another example as shown in FIGS. 8 and 9, there is further provided one or more sifter sheets 120 in association with at least the base portion 102. The sifter sheet 120 may comprise a plastic sheet having a plurality of slits or holes 122 sized so that unused portions of the animal litter 400 may pass through, but animal waste and dirty clumps of litter remain in the sifter sheet 120 when it is lifted through the litter 400 filled in the container. Any suitable number, configuration and size of holes 122 may be used. A handle portion 124 may be provided at each end of the sifter sheet 120 to allow the sheet to be picked up and lifted after litter 400 is introduced into the interior volume 300 In this manner, the disposable litter container may be used for an extended period as but animal waste and dirty clumps of litter may be periodically removed from the litter 400 for continued use of clean litter 400. As the sifter sheet 120 is lifted, any clean, reusable granules of animal litter fall through sheet 120 and down into the interior volume 300 for continued use. The user may then add additional animal litter if needed. If a plurality of sifter sheets 120 are provided, an individual sheet may be separated from any others to allow removal of animal waste and dirty clumps of litter successively.

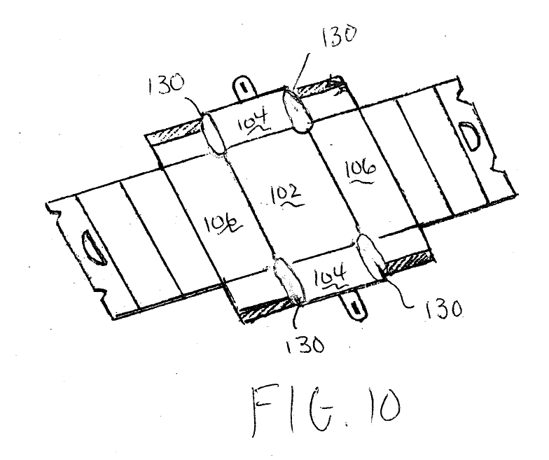

In another example, there is provided sealing tabs 130 as shown in FIG. 10, provided adjacent the intersection of the end portions 104 and side portions 106 along with tabs 114. The sealing tabs 130 may be formed of a moisture proof material and provided with an adhesive on a portion thereof adjacent this intersection. A release liner may protect the adhesive until use is desired. Upon making the container into the form for use as shown in FIG. 4, the adhesive on the sealing tabs 130 may be exposed and the tabs pressed into and secured in association with the corner formed at the intersection of the end portions 104 and side portions 106 along with tabs 114. In this manner, the sealing tabs effectively seal each of the interior corners formed around the interior volume 300 of the container to prevent any egress of urine or moisture from the formed container.

It is intended that the invention not be limited to the particular embodiments disclosed as the best mode contemplated for carrying out this invention, but that the instant invention will include all embodiments falling within the scope of the appended claims.

What is claimed is:

1. A disposable animal litter box comprising
a unitary blank of material, the blank of material comprising
a base portion;
a pair of end portions, the end portions foldably connected to the base portion on opposing ends of the base portion;
a pair of side portions, the side portions foldably connected to the base portion on opposing sides of the base portion;
a lid portion foldably connected to each side portion; and
a handle portion foldably connected to each lid portion;
wherein the end portions and side portions are positioned in diametrically opposed relationship and one of the pair of side portions or pair of end portions have an adhesive over at least a portion thereof, such that upon folding up the pair of end portions, and folding up the pair of side portions, the adhesive allows each side portion to be adhered to both end portions, thereby forming an enclosed interior volume with an open top for placement of litter therein.

2. The disposable animal litter box of claim 1 further comprising a lid portion foldably connected to each side portion, and a handle portion foldably connected to each lid portion.

3. The disposable animal litter box of claim 1 wherein upon moving the lid portions to the closed position, the opposing handle portions are positioned adjacent one another for grasping.

4. The disposable animal litter box of claim 3 wherein the pair of end portions each comprise a latch tab which receives an end of the handle portions when adjacent one another to lock the lid portions and handle portions in position.

5. The disposable animal litter box of claim 3 further comprising an adhesive provided on at least one of the opposing handle portions to secure the handle portions together when positioned adjacent one another.

6. The disposable animal litter box of claim 1 wherein at least one of the sides of the foldable piece of material is moisture proof.

7. The disposable animal litter box of claim 2 wherein at least one handle portion has an adhesive to allow the handle portions to be secured to one another upon the lid portions being moved to the closed position and the opposing handle portions moved to be adjacent one another.

8. The disposable animal litter box of claim 1 further comprising at least one sifter sheet having a plurality of openings sized so that unused portions of litter may pass through, but animal waste and dirty clumps of litter remain in the sifter sheet when it is lifted.

9. The disposable animal litter box of claim 8 wherein there are a plurality of sifter sheets wherein an individual sifter sheet may be separated from any others to allow removal of animal waste and dirty clumps of litter successively.

10. The disposable animal litter box of claim 1 wherein at least a portion of the piece of material is scented.

11. The disposable animal litter box of claim 2 wherein the lid portions include a plurality of panels that are foldable into a position adjacent the side portion until the lid portion is moved to the closed position.

12. The disposable animal litter box of claim 11 wherein at least one panel of the lid portions has an adhesive to allow the panels of the lid portions to be secured to one another and to allow the lid portions to be secured to the side portions to enable access to the interior volume.

13. A disposable animal litter box comprising
a unitary blank of material comprising a base portion, a pair of opposing end portions and a pair of opposing side portions, the end portions and side portions foldably connected to the base portion on opposing sides of the base portion, and a pair of lid portions foldably connected to each side portion,
wherein the end portions and side portions are positioned in diametrically opposed relationship and one of the pair of side portions or pair of end portions have an adhesive over at least a portion thereof, such that upon folding up the pair of end portions, and folding up the pair of side portions, the adhesive allows each side portion to be adhered to both end portions, thereby forming an enclosed interior volume with an open top for placement of litter therein, and the lid portions movable into a closed position over the interior volume for disposal.

14. The disposable animal litter box of claim 13 further comprising sealing tabs positioned adjacent the corners formed upon folding up the pair of end portions and pair of side portions, wherein the sealing tabs are pressed into and secured in association with the corner formed at the intersection of the end portions and side portions to seal the corners of the interior volume.

15. The disposable animal litter box of claim 14 wherein the sealing tabs are formed of a moisture proof material.

16. The disposable animal litter box of claim 14 wherein the sealing tabs are provided with an adhesive on a portion thereof adjacent the intersection of the end portions and side portions.

17. The disposable animal litter box of claim 13 further comprising a handle portion on each lid portion, with at least one handle portion having an adhesive to allow the handle portions to be secured to one another upon the lid portions being moved to a closed position wherein the opposing handle portions are correspondingly moved to be adjacent one another.

18. The disposable animal litter box of claim 12 further comprising at least one sifter sheet having a plurality of openings sized so that unused portions of litter may pass through, but animal waste and dirty clumps of litter remain in the sifter sheet when it is lifted.

19. The disposable animal litter box of claim 18 further comprising a plurality of sifter sheets wherein an individual sifter sheet may be separated from any others to allow removal of animal waste and dirty clumps of litter successively.

20. A kit for the construction and use of a disposable animal litter box, the kit comprising
at least one unitary flat blank of material comprising
a base portion, a pair of opposing end portions and a pair of opposing side portions, the end portions and side portions foldably connected to the base portion on opposing sides of the base portion, and a lid portion foldably connected to each side portion; and
an amount of animal litter.
